(19) United States
(12) Patent Application Publication
(10) Pub. No.: US 2004/0154696 A1
(43) Pub. Date: Aug. 12, 2004

(54) Hood funnel

(76) Inventors: Lawrence J. Koncelik JR., East Hampton, NY (US); William Bruder, Bridgehampton, NY (US)

Correspondence Address: Mr. Walter J. Tencza Jr., Suite 3, 10 Station Place, Metuchen, NJ, 08840, US

(21) Appl. No.: 10/795,784

(22) Filed: Mar. 8, 2004

(51) Int. Cl. B67C 11/04

(52) U.S. Cl. 141/331; 141/341

(57) ABSTRACT

A funnel is disclosed that can be attached by a mounting device to a vehicle. This allows the motorist to have a funnel immediately available to make the job of pouring oil or other liquids into a vehicle easier. A mounting device is provided that can be attached by any common attachment means such as a peelable adhesive, to existing vehicles. In another embodiment a mounting clip can be permanently integrated onto the interior of a hood of a car when the car is manufactured. A funnel may be capable of being attached and detached from the mounting clip. The mounting device may include one or more clips. The mounting device may include a clamping device.

### FIELD OF THE INVENTION

This invention relates to improved methods and apparatus concerning

### BACKGROUND OF THE INVENTION

Pouring oil, or other liquids (e.g. transmission fluid) into vehicle engines can cause unwanted oil spills. To avoid this a motorist will often have to take time out to obtain a funnel from some other location.

### SUMMARY OF THE INVENTION

The present invention in one or more embodiments provides a funnel that can be attached by a mounting device to a vehicle. This allows the motorist to have a funnel immediately available to make the job of pouring oil or other liquids into a vehicle easier. In one or more embodiments a mounting device is provided that can be attached by any common attachment means such as a peelable adhesive, to existing vehicles. In another embodiment a mounting clip can be permanently integrated onto the interior of a hood of a car when the car is manufactured. A funnel may be capable of being attached and detached from the mounting clip. The mounting device may include one or more clips. The mounting device may include a clamping device.

### BRIEF DESCRIPTION OF THE DRAWINGS

FIG. 1 shows a perspective view of an apparatus in accordance with an embodiment of the present invention, wherein the apparatus includes a funnel and a clip attached to the funnel;

FIG. 2A shows a perspective view of a mounting device including a loop or C-shaped device attached to a backing;

FIG. 2B shows a funnel inserted into the mounting device of FIG. 2A;

FIG. 2C shows a rear view of the mounting device of FIG. 2A;

FIG. 3 shows a top view of another mounting device in accordance with another embodiment of the present invention, with the location of an inserted funnel shown in dashed lines;

FIG. 4A shows a perspective view of a funnel inserted into the mounting device of FIG. 3, with the funnel held in a vertical position;

FIG. 4B shows a perspective view of the funnel of FIG. 4A inserted into the mounting device of FIG. 3, with the funnel held on in a horizontal position;

FIG. 5A shows a top view of a clip which can be attached to a funnel and attached to an interior of a hood of a car to attach a funnel to the interior of the hood of a car;

FIG. 5B shows a perspective view of the funnel inserted into the clip of FIG. 5A;

FIG. 6A shows a top view of a clip which can be attached to a funnel and attached to an interior of a hood of a car to attach a funnel to a interior of a hood of a car; and

FIG. 6B shows a perspective view of a funnel inserted into two clips, each of which is the same as the clip in FIG. 6A.

### DETAILED DESCRIPTION OF THE DRAWINGS

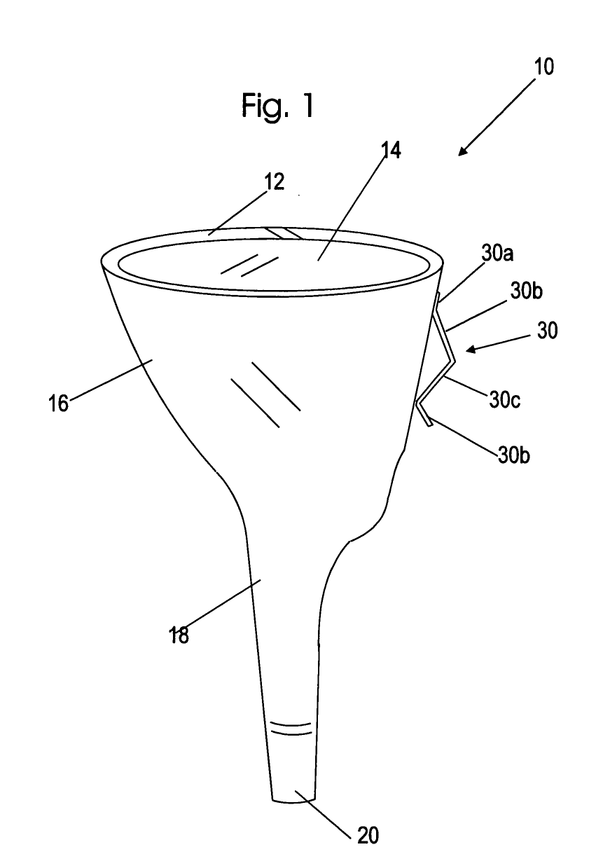

FIG. 1 shows a perspective view of an apparatus 10 in accordance with an embodiment of the present invention, wherein the apparatus 10 includes a funnel 11 and a clip 30 attached to the funnel 11.

The funnel 11 has an edge 12, a top opening 14, a top portion 16, a bottom portion 18, and a bottom opening 20. The top portion 16 narrows in diameter from opening 14 to bottom portion 18. The bottom portion 18 narrows in diameter from portion 16 to bottom opening 20. Liquid is typically poured in the top opening 14 and comes out the bottom opening 20.

The clip 30 can be used to attach the apparatus 10 to the interior of a car hood, such as on an interior front fender of a vehicle or car or on a firewall of a vehicle or car between the engine of the vehicle or car and a cab of the vehicle or car. The clip 30 may include portions 30a, 30b, 30c, and 30d. Portion 30a may be glued or otherwise attached to the portion 16 of funnel 11.

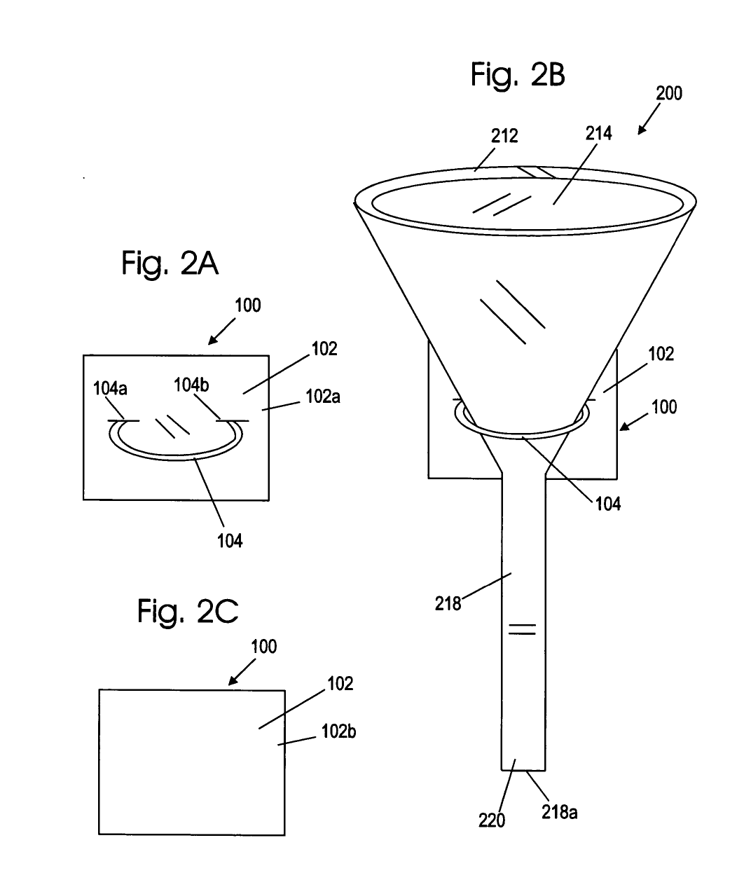

FIG. 2A shows a perspective view of a mounting device 100 including a loop or C-shaped device 104 attached to a backing 102. FIG. 2C shows a rear view of the mounting device 100. The loop 104 may include ends 104a and 104b which are fixed to backing 102. The backing 102 may have a side 102a to which the loop 104 is attached and a side 102b, shown in FIG. 2C, which may have an adhesive for attaching the backing to the interior of a hood of a car or other vehicle.

FIG. 2B shows a perspective view of a funnel 200 inserted into the mounting device 100 of FIG. 2A. The funnel includes an edge 212, an upper portion 216, a lower portion 218, a top opening 214, and a bottom opening 220. The funnel 200 is inserted into the loop 104 of the mounting device 100 by inserting end 218a of the portion 218 through the loop 104.

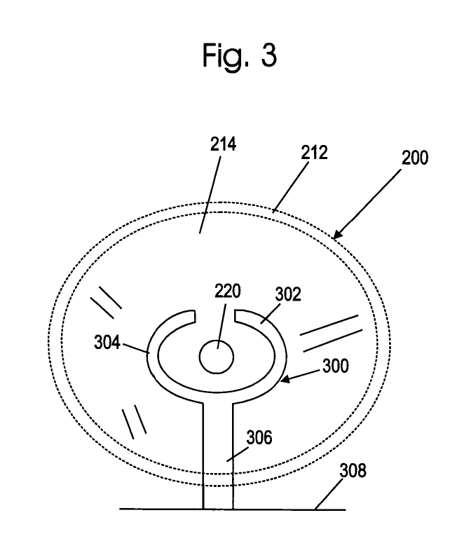

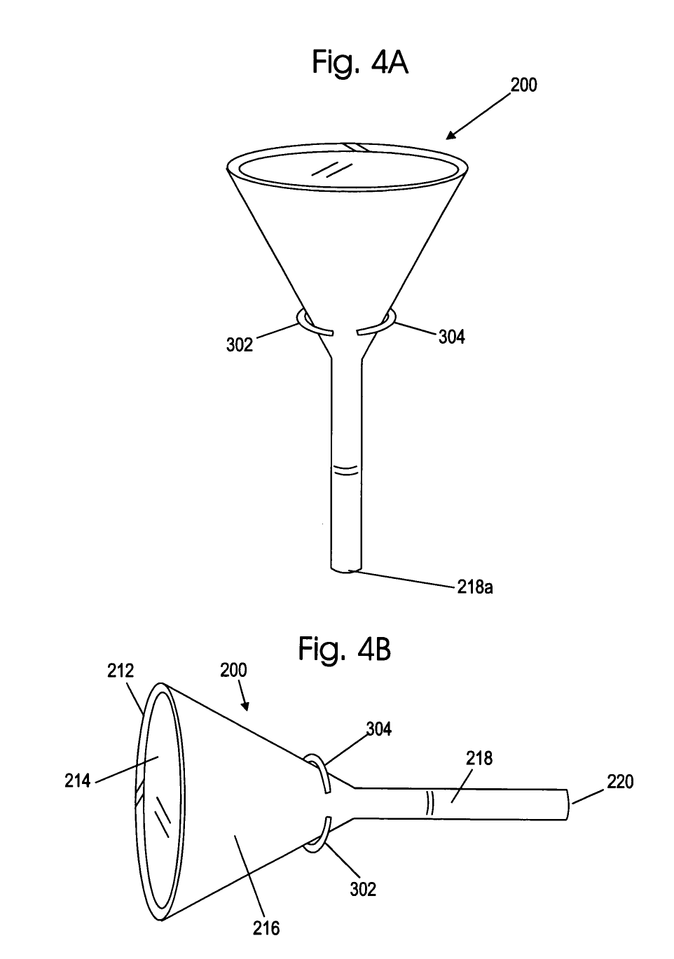

FIG. 3 shows a top view of a mounting device 300 in accordance with another embodiment of the present invention, with the location of an inserted funnel 200 shown in dashed lines. FIG. 4A shows a perspective view of the funnel 200 inserted into the mounting device of 300, with the funnel 200 held in a vertical position. FIG. 4B shows a perspective view of the funnel 200 of FIG. 4A inserted into the mounting device 100 of FIG. 3, with the funnel 200 held on in a horizontal position. The mounting device 300 includes an extension 306, and a loop 305 including portions 302 and 304. The mounting device 300 may be fixed to the interior 308 of a hood of a car. The funnel 200 can be slid down into the loop 305 by inserting end 218a into loop 305 as shown by FIG. 4A. The funnel 200 can be pushed in horizontally by pushing part of portion 216 into loop 305 causing portions 302 and 304 to bend outwards temporarily and thereafter causing portions 302 and 304 to snap back to hold the funnel 200 in the position of FIG. 4B.

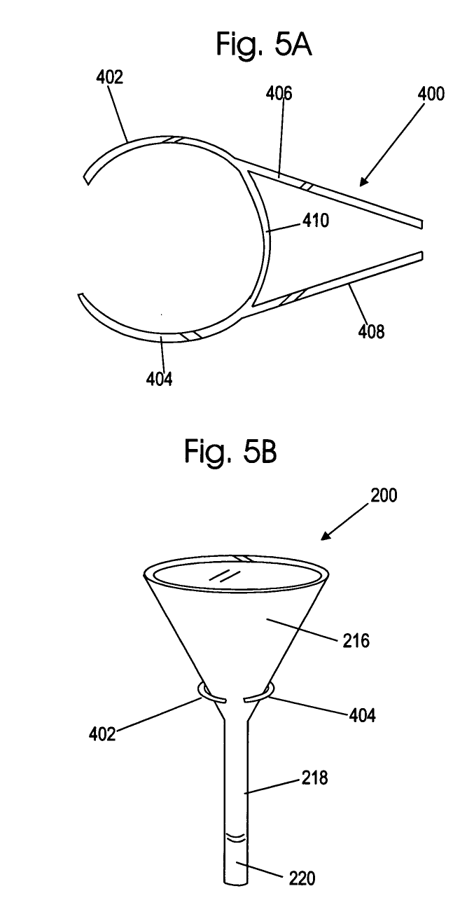

FIG. 5A shows a top view of a clip 400 which can be attached to a funnel, such as funnel 200 and attached to an interior, such as interior 308 of a hood of a car to attach a funnel 200 to the interior of the hood of a car. FIG. 5B shows a perspective view of the funnel 200 inserted into the clip 400 of FIG. 5A. The clip 400 may include portions or arms 402 and 404, and clamp portions 406 and 408, as well as portion 410. The portions or arms 402 and 404 are designed to hold a funnel, such as funnel 200. The clamp portions 406 and 408 are designed to clamp onto the interior of a hood. For example, the clamp portions 406 and 408 can be pressed onto a mounting surface edge and held there semi-permanently in place by a pressured fit.

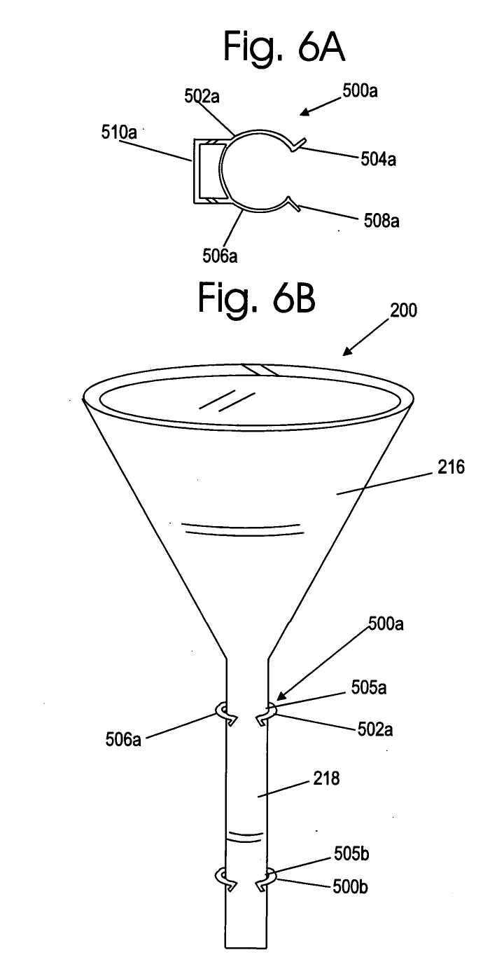

FIG. 6A shows a top view of a clip 500a which can be attached to a funnel, such as funnel 200 and attached to an interior, such as interior 308, of a hood of a car to attach a funnel to a interior of a hood of a car. FIG. 6B shows a perspective view of a funnel 200 inserted into two clips 500a and 500b each of which is the same as the clip 500a in FIG. 6A. The clip 500a is comprised of a backing part 510a which may have an adhesive for attaching to an interior, such as interior 308 of FIG. 3 of a car. The clip 500a may also include portions 502a, 504a, 506a, and 508a.

The funnel 200 can be inserted into the clips 500a and 500b as shown in FIG. 6B by pushing the portion 218 into the inside 505a and 505b of the clips 500a and 500b. This causes portions or arms 502a and 506a to spread and portions or arms 502b and 506b to spread. When the portion 218 of the funnel 200 is inside both 505a and 505b of the clips 500a and 500b, the arms 502a and 506a snap shut and the arms 502b and 506b snap shut, holding the funnel 200 in place and attaching the funnel 200 to an interior of a hood of a car.

A peelable adhesive can be used on the portion 102b of the backing 102 or on portion 510a of the mounting device 500.

The mounting or attached device, such as devices 100, 300, 400, 500a and 500b may be attached anywhere on a vehicle, inside or outside. The devices 100, 300, 400, 500a, and 500b may be attached behind the bumper, inside the trunk, or under the hood, including on the hood itself or on any mounting surface within the engine compartment.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a funnel; and
a mounting device;
wherein the mounting device can mount the funnel to a vehicle.

2. The apparatus of claim 1 wherein
the mounting device includes a clip.

3. The apparatus of claim 1 wherein
the mounting device includes a clamping device.

4. The apparatus of claim 1 wherein
the mounting device includes a first and a second clip.

5. The apparatus of claim 1 wherein
the mounting device can mount the funnel to an interior of a hood of a vehicle.

6. A method comprising:
mounting a funnel to a vehicle.

7. The method of claim 6 wherein
the funnel is mounted with a clip.

8. The method of claim 6 wherein
The funnel is mounted with a clamping device.

9. The method of claim 6 wherein
the funnel is mounted with a first and a second clip.
